(19) United States
(12) Patent Application Publication
(10) Pub. No.: US 2025/0115503 A1
(43) Pub. Date: Apr. 10, 2025

(54) ION SCALE BUSTER WITH FUNCTION THAT ACTIVATES IONS

(71) Applicants: Jincheon KIM, Osan-si (KR); Sungsoo LEE, Busan (KR)

(72) Inventors: Jincheon KIM, Osan-si (KR); Sungsoo LEE, Busan (KR)

(21) Appl. No.: 18/507,088

(22) Filed: Nov. 12, 2023

(30) Foreign Application Priority Data
Oct. 4, 2023 (KR) 10-2022-0126271

(51) Int. Cl. C02F 5/08; C02F 1/48

(52) U.S. Cl. CPC C02F 5/08; C02F 1/482; C02F 2201/002; C02F 2301/026; C02F 2303/08; C02F 2307/14

(57) ABSTRACT

Disclosed is an ion scale buster with a function that activates ions, the ion scale buster being capable of allowing effects made by electrons and ions in water to continue over a longer distance by increasing activity by micronizing water molecules and amplifying energy of electrons and ions in water.

### CROSS-REFERENCE TO RELATED APPLICATIONS

This application claims the priority of Korean Patent Application No. 10-2022-0126271 filed on Oct. 4, 2022, in the Korean Intellectual Property Office, the disclosure of which is incorporated herein by reference.

### BACKGROUND

### Field

The present disclosure relates to an ion scale buster installed in a tap water supply pipe to suppress corrosion of the pipe, and more particularly, to an ion scale buster with a function that activates ions, the ion scale buster being installed in a pipe, in which tap water flows, and configured to suppress and eliminate corrosion and scale by discharging zinc ions and electrons into the flowing water, induce atomization of water and inorganic molecules, promote activation of ions and electrons contained in water to suppress and eliminate rust and scale, and allow the effects of ions and electrons to continue over a longer distance.

### Description of the Related Art

In general, rust occurs as active oxygen in water reacts with iron in a pipe when the pipe such as a tap water supply pipe or a water supply pipe or a water drain pipe of a water tank, through which water passes, is used for a long time. The rust and foreign substances are deposited and cause scale, slime, slurry, and the like in the pipe, which shortens a lifespan of the pipe and obstructs a flow of water. Water passing through the pipe also contains various types of harmful materials such as iron oxide or impurities and bacteria, which are harmful to human bodies, which creates an unhygienic water supply environment.

In the related art, a pipe with a corroded interior is replaced with a new pipe in order to eliminate unhygienic factors caused by the corrosion of the interior of the pipe. However, there is a problem in that a large amount of time, a large amount of labor, and a number of facilities are required to replace the existing pipes with new pipes.

Therefore, a method of preventing corrosion of the pipe and removing scale formed in the pipe by using an ionic water treatment apparatus instead of replacing the corroded pipe is used together with the method of replacing the pipe.

Patent Document 1 discloses an example of an ionic water treatment apparatus in the related art.

The ionic water treatment apparatus disclosed in Patent Document 1 includes a tubular outer container made of a stainless material, a tubular inner container inserted into the outer container and made of copper, and a plurality of fluorine resin plates and zinc plates repeatedly disposed in a flow direction of water in the inner container.

It is known that the corrosion of the pipe is caused as rust (iron oxide, Fe₂O₃) is created as iron (Fe) ions in the pipe are bonded to oxygen in water, and scale is created as inorganic materials are attached to the pipe.

The ionic water treatment apparatus uses a potential difference between the zinc plate and the inner container made of copper and promotes an ionization phenomenon in which water particles are divided into cations and anions, and in this case, zinc ions and electrons are eluted into the water from the zinc plate. The zinc ions eluted into the water are more highly likely to be ionized than iron, which may suppress the ionization of iron in the pipe and prevent corrosion of the pipe by suppressing the ionization of iron.

However, a significantly large amount of water introduced into the ionic water treatment apparatus quickly passes through the ionic water treatment apparatus while creating a rectilinear flow through holes formed in the fluorine resin plates and the zinc plates. For this reason, a sufficient amount of zinc ions cannot be eluted into the water, and the eluted zinc ions and electrons have low energy and thus have low activity, which causes a problem in that a degree of the continuity of the suppression of scale and corrosion caused by zinc ions and electrons is low.

Meanwhile, in the related art, a method of adding compounds such as phosphates, silicates, or the like and an electrolysis method are used as a method of suppressing crystallization of water and inorganic materials to suppress or remove corrosion or scale. However, the method of adding the compounds has a disadvantage in that a hydrogen-ion concentration (pH) of water is changed as an elemental composition of the water is changed. The electrolysis method has a disadvantage in that there is almost no continuity because of ion regression when the water and inorganic material depart from an electrolysis device although the hydrogen-ion concentration is not changed.

### DOCUMENT OF RELATED ART

### Patent Document

(Patent Document 1) Korean Patent No. 10-1460042 (published on Nov. 10, 2014)

### SUMMARY

An object to be achieved by the present disclosure is to provide an ion scale buster with a function that activates ions, the ion scale buster being capable of allowing effects made by zinc ions and electrons to continue over a longer distance by increasing activity by micronizing water and inorganic molecules and amplifying energy of electrons and zinc ions eluted into water.

According to an aspect of the present disclosure, an ion scale buster with a function that activates ions and includes: a tubular housing having an inlet port formed at one side thereof, and a discharge port formed at a side opposite to the inlet port; a copper pipe made of copper and installed and structured to be in close contact with an inner peripheral surface of the tubular housing; a first water treatment member disposed in the copper pipe so as to come into earliest contact with water introduced into the tubular housing, the first water treatment member being made of copper, having a two-stage structure including a large-diameter portion provided to be in close contact with the inner peripheral surface of the copper pipe, and a small-diameter portion spaced apart from the inner peripheral surface of the copper pipe, and configured such that the water is introduced through a central portion of the large-diameter portion and then discharged into a space between the small-diameter portion and the copper pipe while being distributed in a circumferential direction of the small-diameter portion; a second water treatment member made of zinc and having a two-stage structure including a large-diameter portion provided to be in close contact with the inner peripheral surface of the copper pipe, and a small-diameter portion spaced apart from the inner peripheral surface of the copper pipe, the second water treatment member being disposed in the copper pipe so that the small-diameter portion faces the small-diameter portion of the first water treatment member and configured such that the water is introduced inward through the small-diameter portion and then discharged through a central portion of the large-diameter portion; magnets installed outside the copper pipe to form a magnetic field between the first water treatment member and the second water treatment member; a third water treatment member made of polytetrafluoroethylene and having a two-stage structure including a large-diameter portion provided to be in close contact with the inner peripheral surface of the copper pipe, and a small-diameter portion spaced apart from the inner peripheral surface of the copper pipe, the third water treatment member being disposed in the copper pipe so that the large-diameter portion faces the large-diameter portion of the second water treatment member and configured such that the water introduced inward through a central portion of the large-diameter portion and then discharged into a space between the small-diameter portion and the copper pipe while being distributed in a circumferential direction of the small-diameter portion; and a fourth water treatment member made of copper and having a two-stage structure including a large-diameter portion provided to be in close contact with the inner peripheral surface of the copper pipe, and a small-diameter portion spaced apart from the inner peripheral surface of the copper pipe, the fourth water treatment member being disposed in the copper pipe so that the small-diameter portion faces the small-diameter portion of the third water treatment member and configured such that the water is introduced through the small-diameter portion and then discharged through a central portion of the large-diameter portion.

Meanwhile, the ion scale buster may further include: a plurality of first space forming protrusions protruding from an end surface of the small-diameter portion of the first water treatment member toward the second water treatment member and spaced apart from one another in the circumferential direction of the small-diameter portion to define water inlet ports through which the water is introduced; and a plurality of second space forming protrusions protruding from an end surface of the small-diameter portion of the second water treatment member toward the first water treatment member and spaced apart from one another in the circumferential direction of the small-diameter portion to define water inlet ports through which the water is introduced, the second space forming protrusions being in close contact with the first space forming protrusions while facing the first space forming protrusions so that the first water treatment member and the second water treatment member are spaced apart from each other to define an activation space.

Meanwhile, in the ion scale buster, the magnets may be installed on the copper pipe, positioned in a section between the first water treatment member and the second water treatment member, and configured to form a magnetic field in the activation space.

Meanwhile, in the ion scale buster, the second water treatment member may include: a plurality of first inflow holes formed and distributed in the end surface of the small-diameter portion so that the water in the activation space is introduced into the large-diameter portion; and a plurality of second inflow holes distributed in the circumferential direction between the small-diameter portion and the large-diameter portion, disposed in an obliquely inclined posture, and connected to an internal space of the large-diameter portion.

Meanwhile, in the ion scale buster, two opposite surfaces of the first space forming protrusion and two opposite surfaces of the second space forming protrusion, which define the water inlet port, may be formed to be inclined so that the water introduced into the activation space through the water inlet port creates a flow swirling in the activation space.

The present disclosure having the above-mentioned features may allow inorganic ions and electrons to continue over a long period of time by micronizing water and inorganic molecules and promoting the activation of electrons and inorganic ions eluted into the water, thereby enabling the effect of suppressing and eliminating rust and scale by means of inorganic ions and electrons to continue over a longer distance.

Further, the activation space may be defined between the first water treatment member made of copper and the second water treatment member made of zinc, and a part of the water discharged from the first water treatment member may be introduced into the activation space and collide with zinc ions and electrons released from the second water treatment member, thereby further promoting the activation of inorganic ions and electrons.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a partially cut-away perspective view illustrating an ion scale buster according to an exemplary embodiment of the present disclosure;

FIG. 2 is a cross-sectional view illustrating an internal structure of the ion scale buster according to the exemplary embodiment of the present disclosure;

FIG. 3 is an exploded perspective view of the ion scale buster according to the exemplary embodiment of the present disclosure;

FIG. 4 is a cross-sectional view illustrating an internal structure of a tubular housing according to the exemplary embodiment of the present disclosure;

FIG. 5 is a perspective view of a first water treatment member according to the exemplary embodiment of the present disclosure;

FIG. 6 is a perspective view of a second water treatment member according to the exemplary embodiment of the present disclosure;

FIG. 7 is a perspective view of a third water treatment member according to the exemplary embodiment of the present disclosure;

FIG. 8 is a perspective view of a fourth water treatment member according to the exemplary embodiment of the present disclosure;

FIG. 9 is a front view of the second water treatment member and illustrates a structure in which a lateral surface of the second space forming protrusion according to the present disclosure is inclined; and

FIG. 10 is an exemplified view illustrating a state in which zinc ions and electrons move while colliding with a flow of water in an activation space according to the present disclosure.

### DETAILED DESCRIPTION OF THE EMBODIMENT

Hereinafter, exemplary embodiments of the present

disclosure will be described in detail with reference to the accompanying drawings. In the description of the present disclosure, the specific descriptions of related well-known functions or configurations will be omitted when it is determined that the specific descriptions may unnecessarily obscure the subject matter of the present disclosure.

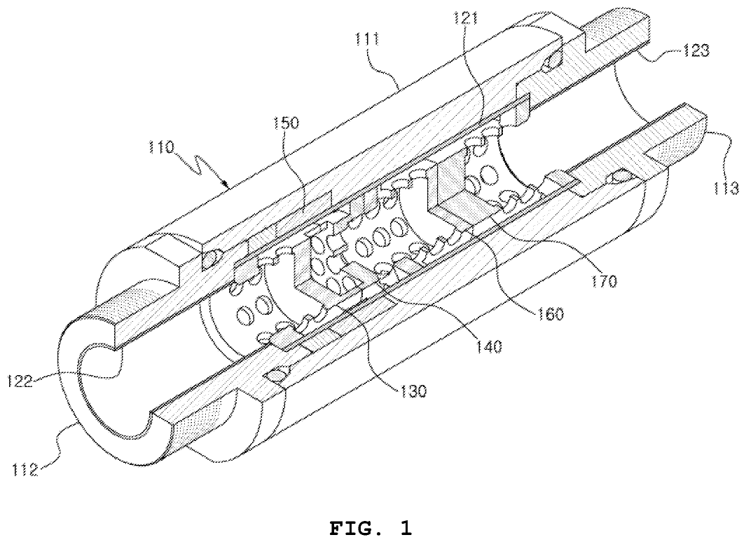

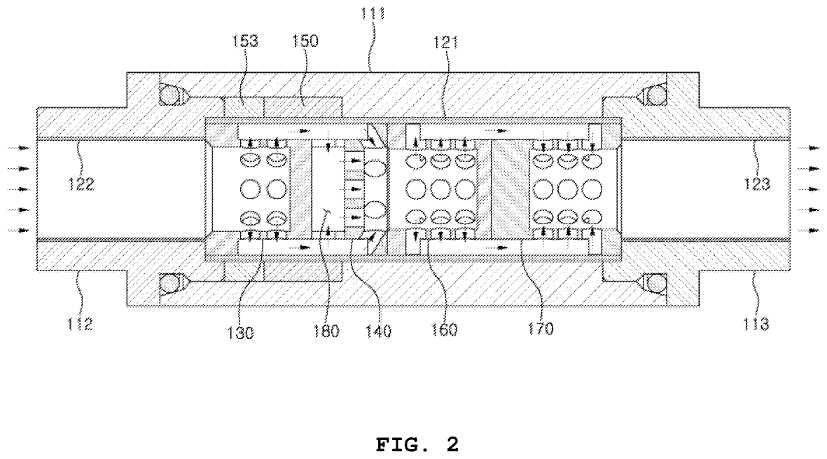

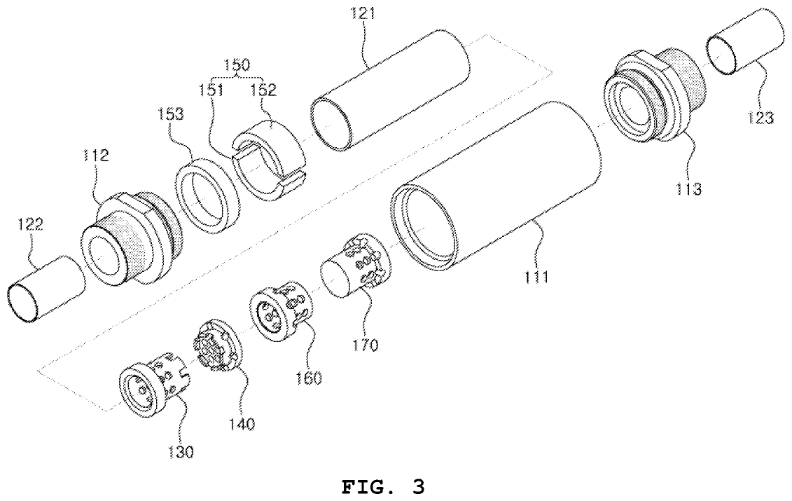

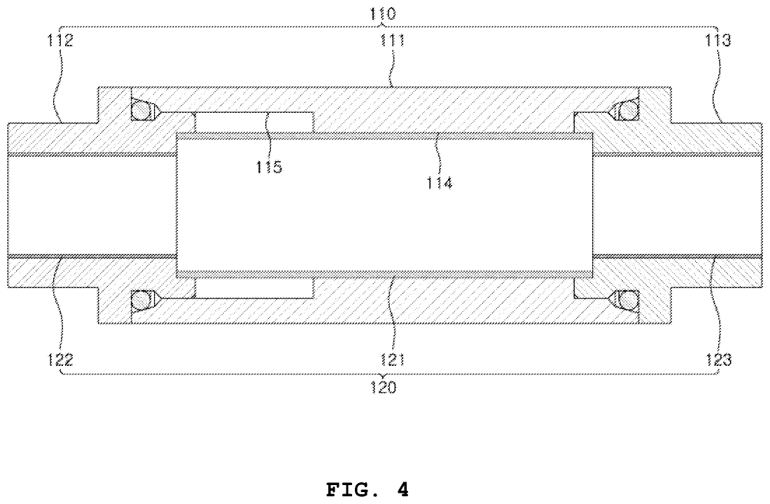

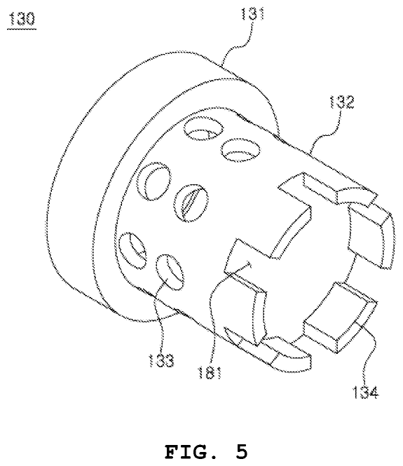

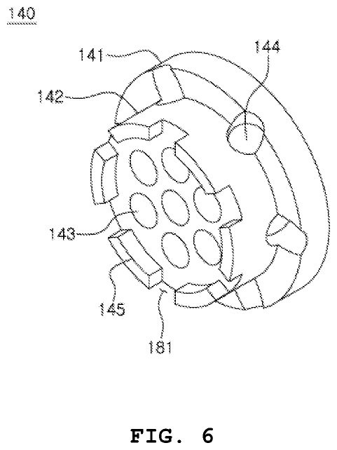

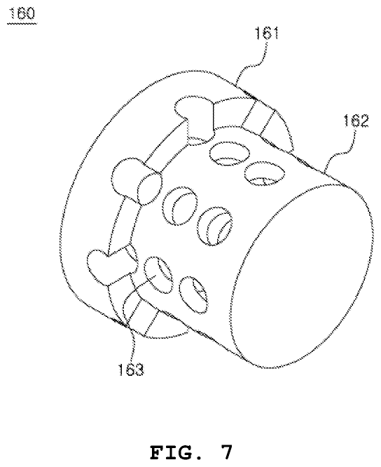

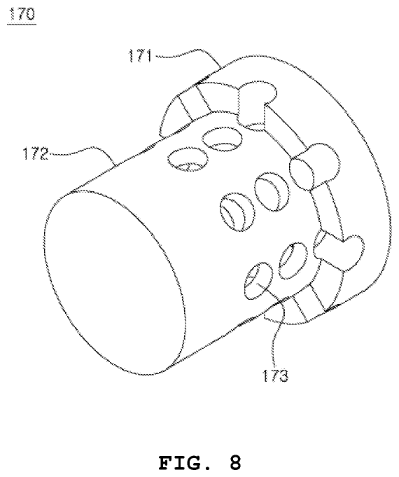

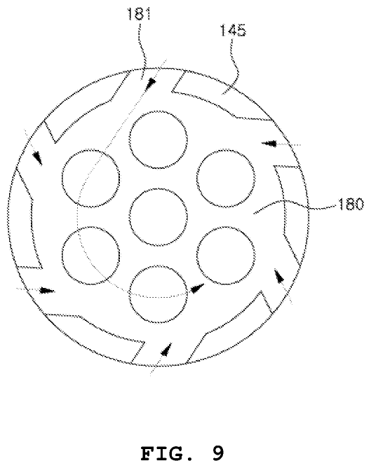

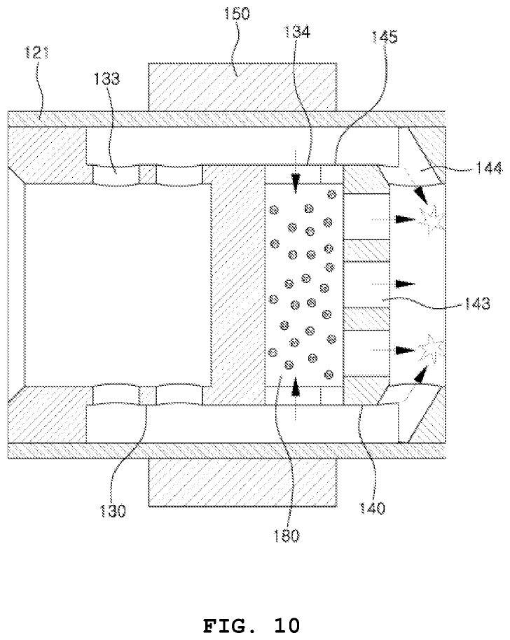

FIG. 1 is a partially cut-away perspective view illustrating an ion scale buster according to an exemplary embodiment of the present disclosure, FIG. 2 is a cross-sectional view illustrating an internal structure of the ion scale buster according to the exemplary embodiment of the present disclosure, FIG. 3 is an exploded perspective view of the ion scale buster according to the exemplary embodiment of the present disclosure, FIG. 4 is a cross-sectional view illustrating an internal structure of a tubular housing according to the exemplary embodiment of the present disclosure, FIG. 5 is a perspective view of a first water treatment member according to the exemplary embodiment of the present disclosure, FIG. 6 is a perspective view of a second water treatment member according to the exemplary embodiment of the present disclosure, FIG. 7 is a perspective view of a third water treatment member according to the exemplary embodiment of the present disclosure, FIG. 8 is a perspective view of a fourth water treatment member according to the exemplary embodiment of the present disclosure, FIG. 9 is a front view of the second water treatment member and illustrates a structure in which a lateral surface of the second space forming protrusion according to the present disclosure is inclined, and FIG. 10 is an exemplified view illustrating a state in which zinc ions and electrons move while colliding with a flow of water in an activation space according to the present disclosure.

An ion scale buster with a function that activates ions according to the present disclosure includes a tubular housing 110, a copper pipe 120, a first water treatment member 130, a second water treatment member 140, magnets 150, a third water treatment member 160, and a fourth water treatment member 170. The ion scale buster is configured such that water introduced from one side of the tubular housing 110 sequentially passes through the first, second, third, and fourth water treatment members 130, 140, 160, and 170 and then is discharged to the other side of the tubular housing 110.

The tubular housing 110 is configured by screw-coupling a first flange part 112 having an inlet port to one side of a body part 111 having a cylindrical structure and by screw-coupling a second flange part 113 having a discharge port to the other side of the body part 111.

Meanwhile, a first inner-diameter portion 114 is formed in the body part 111 so that a first copper pipe 121 to be described below is installed to be in close contact with the first inner-diameter portion 114. A second inner-diameter portion 115 is formed in the body part 111 so that the magnets 150 are installed to be in close contact with the second inner-diameter portion 115. The second inner-diameter portion 115 is formed to have a larger inner diameter than the first inner-diameter portion 114.

The first and second flange parts 112 and 113 are assembled to the body part 111 by screw-coupled in a state in which the first and second flange parts 112 and 113 are partially inserted into the body part 111. An inner diameter of each of the first and second flange parts 112 and 113 is smaller than an inner diameter of the body part 111, and external thread portions are formed at outer ends of the first and second flange parts 112 and 113 so as to be coupled to the pipe.

The copper pipe 120 is installed inside the tubular housing 110 so as to come into contact with water passing through the tubular housing 110.

More specifically, the copper pipe 120 according to the exemplary embodiment of the present disclosure includes the first copper pipe 121 installed such that an outer peripheral surface thereof is in close contact with an inner peripheral surface of the body part 111, a second copper pipe 122 installed such that an outer peripheral surface thereof is in close contact with an inner peripheral surface of the first flange part 112, and a third copper pipe 123 installed such that an outer peripheral surface thereof is in close contact with an inner peripheral surface of the second flange part 113. All the first, second, and third copper pipes 121, 122, and 123 are made of copper (Cu).

Meanwhile, the first copper pipe 121 is assembled to the body part 111 while penetrating the first inner-diameter portion 114, one end of the first copper pipe 121 is inserted into the first flange part 112 and coupled to the first flange part 112, and the other end of the first copper pipe 121 is inserted into the second flange part 113 and coupled to the second flange part 113.

The first water treatment member 130 is provided in the first copper pipe 121 and installed on an inner tip portion of the first copper pipe 121 so as to come into earliest contact with the water introduced into the tubular housing 110. The first water treatment member 130 is made of copper (Cu) and has a two-stage structure including a large-diameter portion 131 and a small-diameter portion 132.

An outer peripheral surface of the large-diameter portion 131 of the first water treatment member 130 is formed to be in close contact with the inner peripheral surface of the first copper pipe 121, an outer peripheral surface of the small-diameter portion 132 of the first water treatment member 130 is formed to be spaced apart from the inner peripheral surface of the first copper pipe 121, and a plurality of first discharge holes 133 is formed around a circumference of the small-diameter portion 132 and distributed in circumferential and length directions.

In addition, among the two opposite ends of the first water treatment member 130, the end adjacent to the large-diameter portion 131 is opened, and the end adjacent to the small-diameter portion 132 is closed. The first water treatment member 130 is installed in the first copper pipe 121 so that the water introduced into the tubular housing 110 is introduced into the first water treatment member 130 through the large-diameter portion 131 and then discharged to a space defined between the first copper pipe 121 and the small-diameter portion 132 while being distributed in the circumferential direction of the small-diameter portion 132 through the plurality of first discharge holes 133.

The second water treatment member 140 is installed inside the first copper pipe 121 and positioned rearward of the first water treatment member 130 based on the direction in which the water flows. The second water treatment member 140 is made of zinc (Zn) and has a two-stage structure including a large-diameter portion 141 and a small-diameter portion 142.

An outer peripheral surface of the large-diameter portion 141 of the second water treatment member 140 is formed to be in close contact with the inner peripheral surface of the first copper pipe 121, and an outer peripheral surface of the small-diameter portion 142 of the second water treatment member 140 is formed to be spaced apart from the inner peripheral surface of the first copper pipe 121.

In addition, among the two opposite ends of the second water treatment member 140, the end adjacent to the large-diameter portion 141 is opened, and the end adjacent to the small-diameter portion 142 is closed. The second water treatment member 140 is installed in the first copper pipe 121 so that the small-diameter portion 142 faces the small-diameter portion 132 of the first water treatment member 130 so that the water is introduced into the second water treatment member 140 through the small-diameter portion 142 and then discharged through the large-diameter portion 141.

In addition, a plurality of first inflow holes 143 is formed and distributed in an end surface of the small-diameter portion 142 of the second water treatment member 140 so that the water is introduced into the second water treatment member 140 through the small-diameter portion 142. A plurality of second inflow holes 144 is formed in a boundary region between the large-diameter portion 141 and the small-diameter portion 142 of the second water treatment member 140 and distributed in the circumferential direction so that the water in the copper pipe 120 may be introduced into the second water treatment member 140.

In this case, the second inflow holes 144 extend in obliquely inclined postures and are connected to an interior of the large-diameter portion 141 so that the water introduced into the large-diameter portion 141 through the second inflow holes 144 is guided to collide with a flow of the water introduced into the large-diameter portion 141 through the first inflow holes 143.

Meanwhile, an activation space 180 may be further formed between the first water treatment member 130 and the second water treatment member 140 to induce activation of zinc ions and electrons by amplifying energy of the zinc ions and electrons discharged from the second water treatment member 140.

In order to define the activation space 180, a plurality of first space forming protrusions 134 is formed in an end surface of the small-diameter portion 132 of the first water treatment member 130, and a plurality of second space forming protrusions 145 is formed in an end surface of the small-diameter portion 142 of the second water treatment member 140. The first space forming protrusions 134 and the second space forming protrusions 145 are in close contact with one another while facing one another, such that the activation space 180 is defined between the first water treatment member 130 and the second water treatment member 140.

More specifically, the plurality of first space forming protrusions 134 protrudes from the end surface of the small-diameter portion 132 of the first water treatment member 130 toward the second water treatment member 140, and the plurality of first space forming protrusions 134 is formed to be spaced apart from one another in the circumferential direction of the small-diameter portion 132, thereby defining water inlet ports 181 through which the water in the first copper pipe 121 is introduced into the activation space 180.

The plurality of second space forming protrusions 145 protrudes from the end surface of the small-diameter portion 141 of the second water treatment member 140 toward the first water treatment member 130, and the plurality of second space forming protrusions 145 is formed to be spaced apart from one another in the circumferential direction of the small-diameter portion 141, thereby defining the water inlet ports 181 through which the water in the first copper pipe 121 is introduced into the activation space 180.

Meanwhile, the first space forming protrusions 134 and the second space forming protrusions 145 may be identical in number and structure to one another. A width of each of the space forming protrusions 134 and 145 may be larger than a width of each of the spaces defined between the space forming protrusions 134 and 145, i.e., a width of the water inlet port 181 so that the space forming protrusions 134 and 145 cannot be inserted into the water inlet ports 181.

In addition, the water inlet port 181 defined by the first space forming protrusions 134 and the water inlet port 181 defined by the second space forming protrusions 145 may be connected to each other to define a single water inlet port or separated from each other to define the independent water inlet ports.

In addition, two opposite surfaces of the first space forming protrusion 134 and two opposite surfaces of the second space forming protrusion 145, which define the water inlet ports 181, may be formed to be inclined so that the water introduced into the activation space 180 through the water inlet port 181 creates a flow swirling in the circumferential direction in the activation space 180.

For example, FIG. 8 illustrates a structure in which the two opposite surfaces of the second space forming protrusion 145 are inclined and the lateral surfaces of the two second space forming protrusions 145, which face each other to define the water inlet port 181, are inclined in the same direction so that the water introduced through the water inlet ports 181 defined between the second space forming protrusions 145 creates a flow swirling counterclockwise in the activation space 180. Although not illustrated, the lateral surface of the first space forming protrusion 134 may also be inclined in the same way as the lateral surface of the second space forming protrusion 145.

In addition, a sum of an overall opening area of the water inlet ports 181 defined by the first space forming protrusions 134 and the first space forming protrusions 134 and an overall opening area of the second inflow holes 143 may be equal to or larger than an overall opening area of first discharge holes 133 formed in the small-diameter portion 132 of the first water treatment member 130, such that the water does not stagnate between the first water treatment member 130 and the second water treatment member 140.

The magnets 150 serve to form a magnetic field in the activation space 180 defined between the first water treatment member 130 and the second water treatment member 140 and includes two permanent magnets 151 and 152 each having a semi-circular shape and installed with the first copper pipe 121 interposed therebetween.

Meanwhile, the permanent magnets 151 and 152 are disposed on the second inner-diameter portion 115 of the body part 111 of the tubular housing 110, and a ring-shaped spacer 153 is further installed on the second inner-diameter portion 115 to suppress inadvertent movements of the permanent magnets 150.

The third water treatment member 160 is installed inside the first copper pipe 121 and positioned rearward of the second water treatment member 140 based on the direction in which the water flows. The third water treatment member 160 is made of polytetrafluoroethylene (PTFE) and has a two-stage structure including a large-diameter portion 161 and a small-diameter portion 162.

An outer peripheral surface of the large-diameter portion 161 of the third water treatment member 160 is formed to be in close contact with the inner peripheral surface of the first copper pipe 121, an outer peripheral surface of the small-diameter portion 162 of the third water treatment member 160 is formed to be spaced apart from the inner peripheral surface of the first copper pipe 121, and a plurality of second discharge holes 163 is formed around a circumference of the small-diameter portion 162 and distributed in the circumferential and length directions.

In addition, among the two opposite ends of the third water treatment member 160, the end adjacent to the large-diameter portion 161 is opened, and the end adjacent to the small-diameter portion 162 is closed. The third water treatment member 160 is installed in the first copper pipe 121 so that the large-diameter portion 161 faces the large-diameter portion 141 of the second water treatment member 140 so that the water is introduced into the third water treatment member 160 through the large-diameter portion 161 and then discharged to a space defined between the first copper pipe 121 and the small-diameter portion 162 while being distributed in the circumferential direction of the small-diameter portion 162 through the plurality of second discharge holes 163.

The fourth water treatment member 170 is installed inside

the first copper pipe 121 and positioned rearward of the third water treatment member 160 based on the direction in which the water flows. The fourth water treatment member 170 is made of copper (Cu) and has a two-stage structure including a large-diameter portion 171 and a small-diameter portion 172.

An outer peripheral surface of the large-diameter portion 171 of the fourth water treatment member 170 is formed to be in close contact with the inner peripheral surface of the first copper pipe 121, an outer peripheral surface of the small-diameter portion 172 of the fourth water treatment member 170 is formed to be spaced apart from the inner peripheral surface of the first copper pipe 121, and a plurality of third inflow holes 173 is formed around a circumference of the small-diameter portion 172 and distributed in the circumferential and length directions.

In addition, among the two opposite ends of the fourth water treatment member 170, the end adjacent to the large-diameter portion 171 is opened, and the end adjacent to the small-diameter portion 172 is closed. The fourth water treatment member 170 is installed in the first copper pipe 121 so that the small-diameter portion 172 faces the small-diameter portion 162 of the third water treatment member 160 so that the water is introduced into the fourth water treatment member 170 through the third inflow holes 173 formed in the small-diameter portion 172 and then discharged into the third copper pipe 123 through the large-diameter portion 171.

The ion scale buster with a function that activates ions according to the present disclosure configured as described above is installed in a pipe constructed to supply tap water to a target location.

Meanwhile, the water flowing through the pipe is introduced into the ion scale buster through an inlet port defined by the first flange part 112 and comes into earliest contact with the second copper pipe 122 installed in the first flange part 112. The water is primarily sterilized by the contact with the second copper pipe 122 made of copper (Cu).

The water introduced into the first copper pipe 121 after passing through the second copper pipe 122 is introduced into the first water treatment member 130 through the large-diameter portion 131 of the first water treatment member 130 and discharged into the space between the small-diameter portion 132 and the first copper pipe 121 through the plurality of first discharge holes 133 formed in the small-diameter portion 132 of the first water treatment member 130.

A part of the water discharged into the first copper pipe 121 from the small-diameter portion 132 of the first water treatment member 130 is introduced into the activation space 180 through the water inlet ports 181 connected to the activation space 180 defined between the first water treatment member 130 and the second water treatment member 140. The remaining part of the water is introduced into the large-diameter portion 141 of the second water treatment member 140 through the second inflow holes 144.

Meanwhile, the first water treatment member 130 is made of copper (Cu), the second water treatment member 140 is made of zinc (Zn), and the first water treatment member 130 and the second water treatment member 140 are electrically connected to each other through the first copper pipe 121, such that electrical energy is generated by a potential difference between copper (Cu) and zinc (Zn) between the first water treatment member 130 and the second water treatment member 140, which promotes the ionization of zinc

(Zn). Therefore, zinc ions and electrons are produced from the second water treatment member 140 and contained in the water.

The second water treatment member 140, which is made of zinc (Zn) having a greater tendency to ionize than iron (Fe) and copper (Cu), ionized, which prevents corrosion of the pipe. The electrons produced from the second water treatment member 140 react with rust, thereby suppressing and eliminating rust.

In addition, the zinc ions eluted into the water, the inorganic ions in the water, and the produced electrons are activated, such that cations and anions, which are being solidified into solids, are relaxed and returned to inorganic ions in the water.

Meanwhile, vortices are generated during a process in which the water is discharged from the small-diameter portion 132 of the first water treatment member 130 and collides with an inner wall of the first copper pipe 121 and a process in which the water in the first copper pipe 121 is introduced into the activation space 180 through the water inlet port 181. The vortices induce active collisions between the water and the inorganic molecules and atomize the water and the inorganic molecules.

Further, the atomization of the water and the inorganic molecules is more actively performed by magnetic fields formed in the activation space 180 and formed around the activation space 180 by the magnets 150 installed to be positioned in the boundary region between the first water treatment member 130 and the second water treatment member 140.

Meanwhile, the atomization of water and inorganic molecules may more effectively prevent ions such as Ca²⁺, Mg²⁺, CO₂, and SO₄ in the water from being formed into crystals.

In particular, according to the ion scale buster according to the present disclosure, zinc ions and electrons released into the activation space 180 from the second water treatment member 140 collide with the water introduced into the activation space 180 through the water inlet ports 181 and flow irregularly, such that energy is amplified, and activity is increased. Therefore, galvanic electricity, which is generated between the first and second water treatment members 130 and 140, and the magnetic field, which is formed in the activation space 180 by the magnets 150, further increase the activity of electrons and ions in the water.

In case that the activity of ions and electrons increases as described above, the activation of ions and electrons may continue over a long period of time and increase the time for which the ions and electrons react with rust and scale ions. Therefore, the effects of suppressing and eliminating rust and scale by means of continuous ions and active electrons may continue over a longer distance.

Meanwhile, the water introduced into the activation space 180 is introduced into the large-diameter portion 141 of the second water treatment member 140 through the first inflow holes 143 formed in the second water treatment member 140. In this process, the flow of water introduced into the large-diameter portion 141 through the first inflow holes 143 and the flow of water introduced into the large-diameter portion 141 through the second inflow holes 144 generate vortices while colliding with each other, and in this process, energy of electrons and ions in the water is further amplified.

The water having passed through the second water treatment member 140 is introduced through the large-diameter portion 161 of the third water treatment member 160 made of polytetrafluoroethylene (PTFE) and then discharged into the first copper pipe 121 through the small-diameter portion 162. The flowing process of the water and the friction between the water and the polytetrafluoroethylene (PTFE) generate static electricity, and the activation of electrons and ions in the water is further enhanced by the generated static electricity and the vortices generated during the process in which the water passes through the third water treatment member 160.

The water, which passes through the third water treatment member 160 and is discharged into the first copper pipe 121, is introduced through the small-diameter portion 172 of the fourth water treatment member 170 made of copper (Cu) and then discharged into the third copper pipe 123 through the large-diameter portion 171. The activation of electrons and ions in the water is further enhanced by the static electricity and vortices generated by the flowing process of the water.

Meanwhile, Tables 1 to 4 below show test results and information on corrosion coupons (specimens) used for relative corrosion tests conducted by the Korea Institute of Construction and Living Environment. The relative corrosion tests were conducted by installing specimens in a pipe equipped with the scale buster and a pipe equipped with no scale buster, supplying tap water to the pipes for 20 days, and observing corroded states of the specimens.

TABLE 1
Corrosion coupon surface area (A)

| Corrosion | | | | | | | | |
|---|---|---|---|---|---|---|---|---|
| coupon # | B051 | B052 | B052 | B052 | D329 | D330 | D331 | D332 |
| A | 31.386 | 31.399 | 31.443 | 31.439 | 31.399 | 31.332 | 31.424 | 31.387 |
| (surface area) | | | | | | | | |
| (cm²) | | | | | | | | |

TABLE 2
Average mass reduction of specimens with scale buster

| | | Weight | Weight | | |
|---|---|---|---|---|---|
| | With scale buster | before test | after test | W₁ − | W₁ |
| | Corrosion coupon # | (W₁) (g) | (W₂) (g) | W₂ | (mg/cm²) |
| 1 | B051 | 30.389 | 30.115 | 0.274 | 8.733 |
| 2 | B052 | 30.419 | 30.183 | 0.236 | 7.516 |
| 3 | B053 | 30.421 | 30.204 | 0.218 | 6.917 |
| 4 | B054 | 30.367 | 30.109 | 0.258 | 8.197 |

Wₜ (average) 7.841

$$\text{?} = \frac{{W}_{1} - {W}_{2}}{A}$$

$$\text{?} \text{indicates text missing or illegible when filed}$$

Here, W_{I}: Mass reduction of specimen (mg/cm²)
W1: Initial mass of specimen (mg)
W2: Mass of specimen after removing corroded product (mg)
A: Surface area of specimen (cm²)

TABLE 3
Average mass reduction of specimens without scale buster

| | | Weight | Weight | | |
|---|---|---|---|---|---|
| | Without scale buster | before test | after test | W₁ − | W₁ |
| | Corrosion coupon # | (W₁) (g) | (W₂) (g) | W₂ | (mg/cm²) |
| 1 | D329 | 30.204 | 29.876 | 0.328 | 10.456 |
| 2 | D330 | 30.301 | 29.984 | 0.317 | 10.124 |
| 3 | D331 | 30.281 | 29.912 | 0.369 | 11.749 |
| 4 | D332 | 30.211 | 29.901 | 0.310 | 9.873 |

Wₛ (average) 10.550

$$\text{?} = \frac{{W}_{1} - {W}_{2}}{A}$$

$$\text{?} \text{indicates text missing or illegible when filed}$$

Here, W_{I}: Mass reduction of specimen (mg/cm²)
W1: Initial mass of specimen (mg)
W2: Mass of specimen after removing corroded product (mg)
A: Surface area of specimen (cm²)

TABLE 4
Test result

| Test item | Relative corrosion | Unit |
|---|---|---|
| Test result | % | 74.3 |

$$C ( \% ) = \frac{{W}_{t}}{\text{?}} \times 100$$

$$\text{?} \text{indicates text missing or illegible when filed}$$

Here, C: Relative corrosion rate (%)
Wₜ: Average mass reduction of specimen with scale buster (mg/cm²)
Wₛ: Average mass reduction of specimen without scale buster (mg/cm²)

It can be ascertained that considering that the relative corrosion rate (%) of an ion scale buster generally used in the related art is about 90.3% or more, the ion scale buster of the present disclosure, which implements a low relative corrosion rate (%) of 74.3%, exhibits very excellent performance in suppressing corrosion.

According to the ion scale buster according to the present disclosure described above, the complex operations of copper, galvanic electricity, vortices, magnetic fields, and static electricity promote the activation of electrons and ions in water and enable the activation of electrons and ions in water to continue over a long period of time. Therefore, the present disclosure is a very useful invention capable of enabling the effects implemented by electrons and ions in water to continue over a longer distance.

The present disclosure is not limited to the specific exemplary embodiment described above, various modifications can be made by any person skilled in the art to which the present disclosure pertains without departing from the subject matter of the present disclosure as claimed in the claims, and the modifications are within the scope defined by the claims.

What is claimed is:

1. An ion scale buster with a function that activates ions, the ion scale buster comprising:
a tubular housing (110) having an inlet port formed at one side thereof, and a discharge port formed at a side opposite to the inlet port;
a copper pipe (120) made of copper (Cu) and installed and structured to be in close contact with an inner peripheral surface of the tubular housing (110);
a first water treatment member (130) disposed in the copper pipe (120) so as to come into earliest contact with water introduced into the tubular housing (110), the first water treatment member (130) being made of copper, having a two-stage structure including a large-diameter portion (131) provided to be in close contact with the inner peripheral surface of the copper pipe (120), and a small-diameter portion (132) spaced apart from the inner peripheral surface of the copper pipe (120), and configured such that the water is introduced through a central portion of the large-diameter portion (131) and then discharged into a space between the small-diameter portion (132) and the copper pipe (120) while being distributed in a circumferential direction of the small-diameter portion (132);
a second water treatment member (140) made of zinc (Zn) and having a two-stage structure including a large-diameter portion (141) provided to be in close contact with the inner peripheral surface of the copper pipe (120), and a small-diameter portion (142) spaced apart from the inner peripheral surface of the copper pipe (120), the second water treatment member (140) being disposed in the copper pipe (120) so that the small-diameter portion (142) faces the small-diameter portion (132) of the first water treatment member (130) and configured such that the water is introduced inward through the small-diameter portion (142) and then discharged through a central portion of the large-diameter portion (141);
magnets (150) installed outside the copper pipe (120) to form a magnetic field between the first water treatment member (130) and the second water treatment member (140);
a third water treatment member (160) made of polytetrafluoroethylene (PTFE) and having a two-stage structure including a large-diameter portion (161) provided to be in close contact with the inner peripheral surface of the copper pipe (120), and a small-diameter portion (162) spaced apart from the inner peripheral surface of the copper pipe (120), the third water treatment member (160) being disposed in the copper pipe (120) so that the large-diameter portion (161) faces the large-diameter portion (141) of the second water treatment member (140) and configured such that the water introduced inward through a central portion of the large-diameter portion (161) and then discharged into a space between the small-diameter portion (162) and the copper pipe (120) while being distributed in a circumferential direction of the small-diameter portion (162); and
a fourth water treatment member (170) made of copper (Cu) and having a two-stage structure including a large-diameter portion (171) provided to be in close contact with the inner peripheral surface of the copper pipe (120), and a small-diameter portion (172) spaced apart from the inner peripheral surface of the copper pipe (120), the fourth water treatment member (170) being disposed in the copper pipe (120) so that the small-diameter portion (172) faces the small-diameter portion (162) of the third water treatment member (160) and configured such that the water is introduced through the small-diameter portion (172) and then discharged through a central portion of the large-diameter portion (171).

2. The ion scale buster of claim 1, further comprising:
a plurality of first space forming protrusions (134) protruding from an end surface of the small-diameter portion (132) of the first water treatment member (130) toward the second water treatment member (140) and spaced apart from one another in the circumferential direction of the small-diameter portion (132) to define water inlet ports (181) through which the water is introduced; and
a plurality of second space forming protrusions (145) protruding from an end surface of the small-diameter portion (142) of the second water treatment member (140) toward the first water treatment member (130) and spaced apart from one another in the circumferential direction of the small-diameter portion (142) to define water inlet ports (181) through which the water is introduced, the second space forming protrusions (145) being in close contact with the first space forming protrusions (134) while facing the first space forming protrusions (134) so that the first water treatment member (130) and the second water treatment member (140) are spaced apart from each other to define an activation space (180).

3. The ion scale buster of claim 2, wherein the magnets (150) are installed on the copper pipe (120), positioned in a section between the first water treatment member (130) and the second water treatment member (140), and configured to form a magnetic field in the activation space (180).

4. The ion scale buster of claim 2, wherein the second water treatment member (140) comprises:
a plurality of first inflow holes (143) formed and distributed in the end surface of the small-diameter portion (142) so that the water in the activation space (180) is introduced into the large-diameter portion (141); and
a plurality of second inflow holes (144) distributed in the circumferential direction between the small-diameter portion (142) and the large-diameter portion (141), disposed in an obliquely inclined posture, and connected to an internal space of the large-diameter portion (141).

5. The ion scale buster of claim 2, wherein two opposite surfaces of the first space forming protrusion (134) and two opposite surfaces of the second space forming protrusion (145), which define the water inlet port (181), are formed to be inclined so that the water introduced into the activation space (180) through the water inlet port (181) creates a flow swirling in the activation space (180).
